(19) United States
(12) Patent Application Publication
(10) Pub. No.: US 2007/0025635 A1
(43) Pub. Date: Feb. 1, 2007

(54) Picture signal processor and picture signal processing method

(76) Inventor: Hirotoshi Miyazawa, Fukaya-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/493,805

(22) Filed: Jul. 27, 2006

(30) Foreign Application Priority Data
Jul. 29, 2005 (JP) 2005-220363

(51) Int. Cl. G06K 9/40; G06K 9/00

(52) U.S. Cl. 382/274; 382/169

(57) ABSTRACT

According to one embodiment, histogram data on each of luminance levels is acquired from an input luminance signal for one frame portion, and degree conversion processing is performed to the acquired histogram data on the basis of a conversion parameter which enables designating a histogram on each luminance level. Then, on the basis of the histogram data subjected to the degree conversion, a table for performing a non-linear correction processing to the input luminance signal is created, and a non-linear correction processing is performed to the input luminance signal on the basis of the created table.

### CROSS-REFERENCE TO RELATED APPLICATIONS

This application is based upon and claims the benefit of priority from Japanese Patent Application No. 2005-220363, filed Jul. 29, 2005, the entire contents of which are incorporated herein by reference.

### BACKGROUND

1. Field

One embodiment of the invention relates to improvements of a picture signal processor and a picture signal processing method for performing a gradation correction processing to a luminance signal on the basis of a luminance histogram.

2. Description of the Related Art

As is already known, flat panel-type large-screen displays have been developed in recent years, and have been put to practical use in color television broadcast receivers and the like. Then, in this kind of large-screen displays, a gradation correction processing is performed to a luminance component of a picture signal in order to allow a display image to be clearly displayed.

In particular, in a basic gradation correction processing using a histogram of a luminance under these circumstances, histogram data acquired on respective luminance levels are accumulated and added from the low luminance level, so that a luminance input/output conversion parameter is created.

However, in the case where information is locally concentrated on a specific luminance level in such a gradation correction processing, a luminance inclination at the concentrated portion becomes abruptly steep. On the contrary, it sometimes happen that the luminance inclination becomes substantially absent at a portion where information is absent.

On the contrary, at present, the acquired histogram is handled by setting a limit value both as a lower limit and an upper limit. However, since the processing is a simple discarding and increasing processing, there is a tendency that the advantage becomes weak with respect to the original information.

Japanese Patent No. 2512562 discloses a configuration of a gradation correction device, which prevents an excessive expansion of a dynamic range and performs a more true and high contrast gradation correction by controlling a gradation correction amount on the basis of an average value, a mode value, a maximum value of an input luminance signal, a minimum value, a black area, a white area, a deviation coefficient and the like which are determined from histogram data of the luminance.

Furthermore, Jpn. Pat. Appln. KOKAI Publication No. 2000-322047 discloses a configuration of a gradation correction device, which prevents an excessive spread of a dynamic range of a luminance distribution and performs an optimal gradation correction in accordance with the deviation degree of the luminance distribution of images in such a manner that a correction luminance level for each luminance level is created on the basis of histogram data of the luminance.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a block diagram showing one embodiment of the present invention, the diagram being shown for explaining a picture signal processing system of a television broadcast receiver;

FIG. 2 is a block diagram shown for explaining in detail a picture signal processing unit of the television broadcast receiver in the embodiment;

FIG. 3 is a block diagram shown for explaining in detail a signal correction unit of the picture signal processor in the embodiment;

FIG. 4 is a block diagram shown for explaining in detail a luminance non-linear correction processing unit of the signal correction unit in the embodiment;

FIG. 5 is a flow chart shown for explaining a processing operation of the luminance non-linear correction processing unit in the embodiment;

FIG. 6 is a view shown for explaining histogram data of one frame portion acquired by the luminance non-linear correction processing unit in the embodiment;

FIG. 7 is a view shown for explaining a conversion parameter given to the luminance non-linear correction processing unit in the embodiment;

FIG. 8 is view shown for explaining the details of the conversion parameter given to the luminance non-linear correction processing unit in the embodiment;

FIG. 9 is a view shown for explaining a degree conversion processing which is performed by the luminance non-linear correction processing unit in the embodiment on the basis of the conversion parameter;

FIG. 10 is a view shown for explaining a non-linear correction processing which is performed by the luminance non-linear correction processing unit in the embodiment;

FIG. 11 is view shown for explaining one example of a method of selecting the conversion parameter given to the luminance non-linear correction processing unit in the embodiment;

FIG. 12 is a view shown for explaining one example of the histogram data acquired by the luminance non-linear correction processing unit in the embodiment;

FIG. 13 is a view shown for explaining another example of the histogram acquired by the luminance non-linear correction processing unit in the embodiment;

FIG. 14 is a flow chart shown for explaining a modified example of the processing operation of the luminance non-linear correction processing unit in the embodiment;

FIG. 15 is a view shown for explaining a smoothing processing operation of the histogram data of the non-linear correction processing unit in the embodiment; and

FIG. 16 is a flow chart shown for explaining another modified example of the processing operation of the luminance non-linear correction processing unit in the embodiment.

### DETAILED DESCRIPTION

Various embodiments according to the invention will be described hereinafter with reference to the accompanying drawings. In general, according to one embodiment of the invention, histogram data on each of luminance levels is acquired from an input luminance signal for one frame portion, and degree conversion processing is performed to the acquired histogram data on the basis of a conversion parameter which enables designating a histogram on each luminance level. Then, on the basis of the histogram data subjected to the degree conversion, a table for performing a non-linear correction processing to the input luminance signal is created, and a non-linear correction processing is performed to the input luminance signal on the basis of the created table.

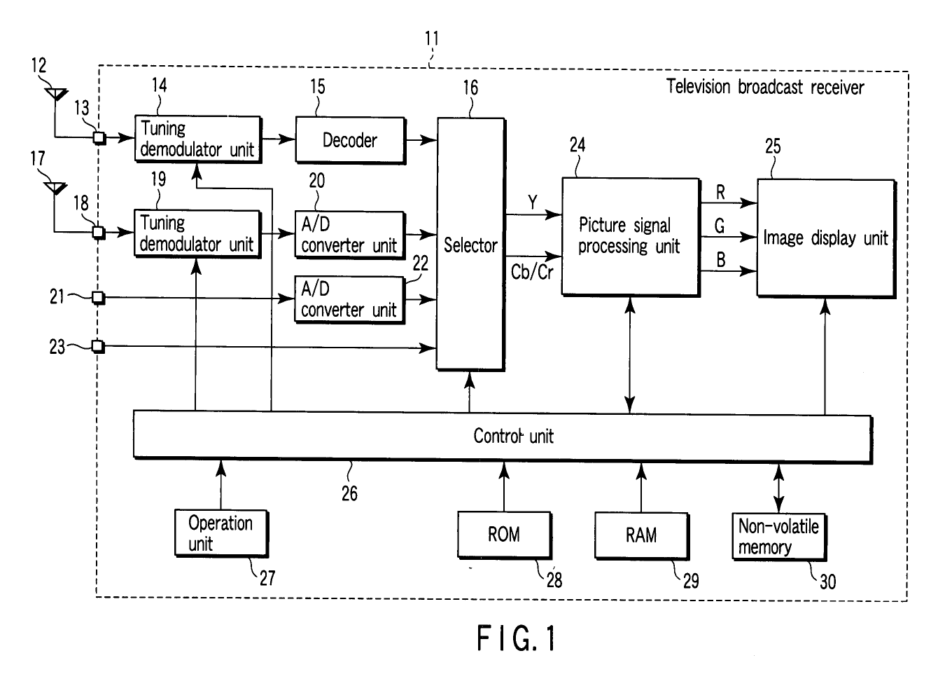

FIG. 1 schematically shows a picture signal processing system of a television broadcast receiver 11 which is explained in the present embodiment.

That is, a digital television broadcast signal received by an antenna 12 for receiving digital television broadcast is supplied to a tuning demodulator unit 14 via an input terminal 13. The tuning demodulator unit 14 tunes a broadcast signal of a desired channel from the input digital television digital television broadcast signal, and demodulates the tuned signal to output the signal to a decoder 15.

Then, the decoder 15 generates a digital luminance signal Y and a color signal Cb/Cr respectively by performing a decoding processing to the signal input from the tuning demodulator unit 14, and outputs the digital luminance signal Y and the color signal Cb/Cr to a selector 16.

Furthermore, an analog television broadcast signal received by an antenna 17 for receiving analog television broadcast is supplied to a tuning demodulator unit 19 via an input terminal 18. The tuning demodulator unit 19 tunes a broadcast signal of a desired channel from the input analog television broadcast signal, and demodulates the tuned signal to generate an analog luminance signal Y and a color signal Cb/Cr, respectively.

Then, after the analog luminance signal Y and the color signal Cb/Cr generated in the tuning demodulator unit 19 are supplied to an A/D (analog/digital) converter unit 20 to be converted into the digital luminance signal Y and the color signal Cb/Cr, the digital luminance signal Y and the color signal Cb/Cr are output to the selector 16.

Further, after the analog luminance signal Y and the color signal Cb/Cr supplied to an external input terminal 21 for analog picture signal are supplied to an A/D converter unit 22 to be converted into the digital luminance signal Y and the color signal Cb/Cr, the digital luminance signal Y and the color signal Cb/Cr are output to the selector 16. Furthermore, the digital luminance signal Y and the color signal Cb/Cr supplied to an external outside input terminal 23 for digital picture signal are supplied to the selector 16 as they are.

Here, the selector 16 selects any one of the digital luminance signals Y and the color signals Cb/Cr supplied respectively from the decoder 15, the A/D converter units 20, 22 and the external input terminal 23, and supplies the selected signal to a picture signal processing unit 24.

Although the details will be described later, the picture signal processing unit 24 generates R(red), G(green), and B(blue) signals by performing a predetermined-signal processing to the input digital luminance signal Y and the color signal Cb/Cr.

Then, R, G and B signals generated by the picture signal processing unit 24 are supplied to an image display unit 25 to provide the image display. For example, a flat panel display composed of a liquid crystal display, a plasma display or the like is adopted as the image display unit 25.

Here, various operations of the television broadcast receiver 11 including various receiving operations described above are uniformly controlled by a control unit 26. The control unit 26 is a micro processor incorporating a central processing unit (CPU) and the like. The control unit 26 receives operation information from an operation unit 27 including a remote controller (not shown) to respectively control each unit in such a manner that the operation contents thereof are reflected.

In this case, the control unit 26 primarily utilizes a read only memory (ROM) 28 having stored therein a control program executed by the CPU, a random access memory (RAM) 29 for providing a work area to the CPU, and a non-volatile memory 30 which stores various set information, control information and the like.

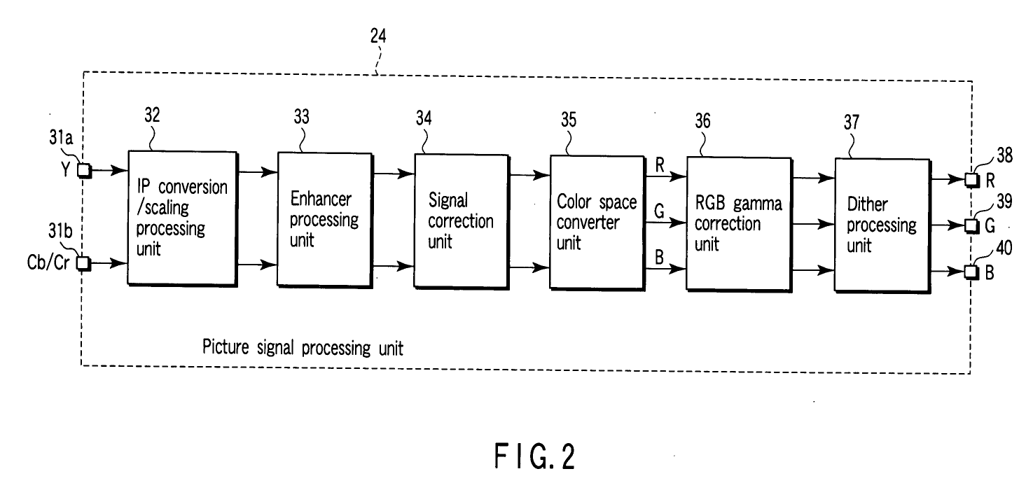

FIG. 2 shows one example of the picture signal processing unit 24. That is, the digital luminance signal Y and the color signal Cb/Cr selected by the selector 16 are supplied to an IP (interlace progressive) conversion/scaling processing unit 32 via input terminals 31a and 31b.

The IP conversion/scaling processing unit 32 performs a progressive conversion processing and a scaling processing to the input luminance signal Y and color signal Cb/Cr in order to provide a display on the image display unit 25 (a flat panel display composed of a liquid crystal display, a flat panel display or the like), and the unit 32 outputs the input luminance signal Y and color signal Cb/Cr to an enhancer processing unit 33.

The enhancer processing unit 33 provides steeper rise in vertical and horizontal directions with respect to the input luminance signal Y and color signal Cb/Cr, or performs enhancing processing for changing a sharpness thereof to output the signals to a signal correction unit 34.

The signal correction unit 34 applies a non-linear correction processing for gradation correction with respect to the input luminance signal Y and applies an amplitude control processing to the color signal Cb/Cr along with the non-linear correction processing to output the signals to a color space converter unit 35.

The color space converter unit 35 converts the input luminance signal Y and color signal Cb/Cr to R, G and B signals to be output to an RGB gamma correction unit 36. The RGB gamma correction unit 36 makes a white balance adjustment to the input R, G and B signals, and applies a gamma correction processing with respect to the image display unit 25 to output the signals to a dither processing unit 37.

Then, the dither processing unit 37 performs a compression processing with respect to the input R, G and B signals, and then outputs the signals to the image display unit 25 via output signals 38, 39 and 40. The compression processing converts a high gradation bit expression in which a bit number is extended for increasing expressiveness into a low gradation bit number corresponding to the image display unit 25.

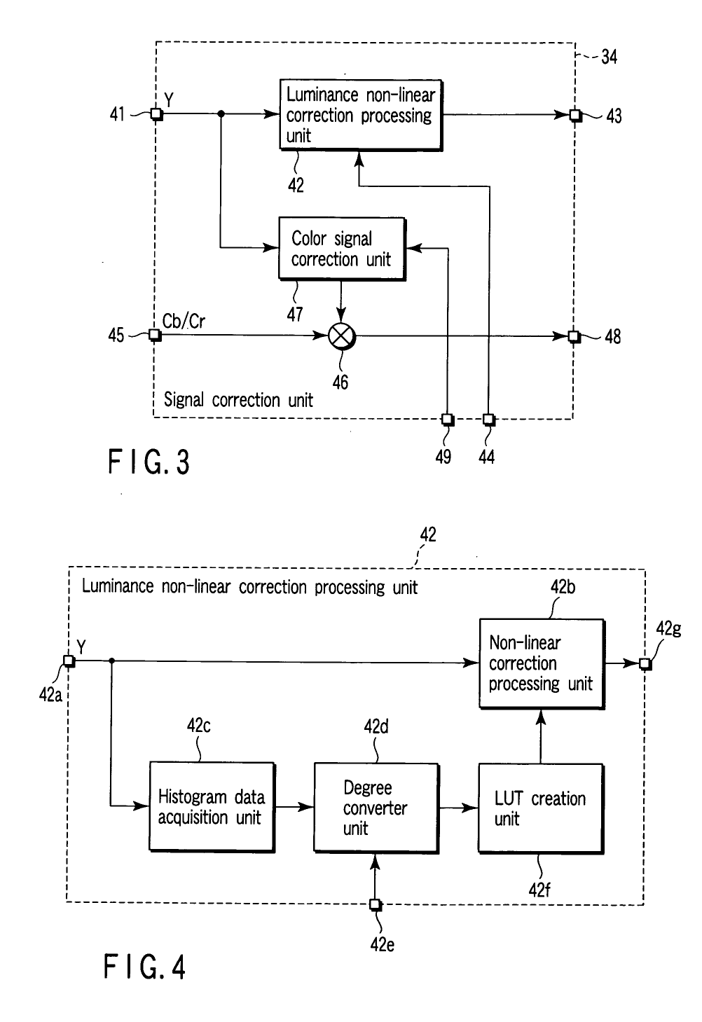

FIG. 3 shows one example of the signal correction unit 34. That is, the luminance signal Y output from the enhancer processing unit 33 is supplied to a luminance non-linear correction processing unit 42 via an input terminal 41, and is subjected to a non-linear correction processing for gradation correction. Thereafter, the signal is output to the color space converter unit 35 via an output terminal 43.

Here, although the details will be described later, the luminance non-linear correction processing unit 42 creates a look-up table (LUT) for luminance non-linear correction processing on the basis of a conversion parameter which is supplied from the control unit 26 via a control terminal 44, and applies a non-linear correction processing to the luminance signal Y on the basis of the LUT.

Furthermore, the color signal Cb/Cr output from the enhancer processing unit 33 is supplied to a multiplier 46 via an input terminal 45, so that a color correction coefficient output from the color signal correction unit 47 is multiplied to perform an amplitude control processing. Thereafter, the signal is output to the color space converter unit 35 via an output terminal 48.

The color signal correction unit 47 retrieves a color correction signal which becomes a color gain for performing an amplitude control to the color signal Cb/Cr on the basis of the level of the luminance signal Y supplied to the input terminal 41, from a LUT for color correction processing which is supplied via a control terminal 49 from the control unit 26, and the retrieved color correction signal is output to the multiplier 46.

FIG. 4 shows the details of the luminance non-linear correction processing unit 42. More specifically, the luminance signal Y supplied to the input terminal 41 passes through an input terminal 42a. Then, the luminance signal Y is supplied to a non-linear correction processing unit 42b and supplied to a histogram data acquisition unit 42c. Out of these units, the histogram data acquisition unit 42c acquires the histogram data on each of the luminance levels with respect to the luminance signal for one frame portion which is input.

Then, the histogram data acquired by the histogram data acquisition unit 42c is supplied to a degree converter unit 42d. The degree converter unit 42d performs a degree conversion processing on the basis of a conversion parameter which can be designated on the histogram data on each luminance level supplied from the control unit 26 via control terminals 44, 42e with respect to the input histogram data, and the data is output to an LUT creation unit 42f.

The LUT creation unit 42f creates a LUT for luminance non-linear correction processing on the basis of the input histogram data after the degree conversion to output the data to the non-linear correction processing unit 42b. The non-linear correction processing unit 42b performs a non-linear correction processing on the basis of the LUT with respect to the input luminance signal, and outputs the signal to the color space converter unit 35 via output terminals 42g, 43.

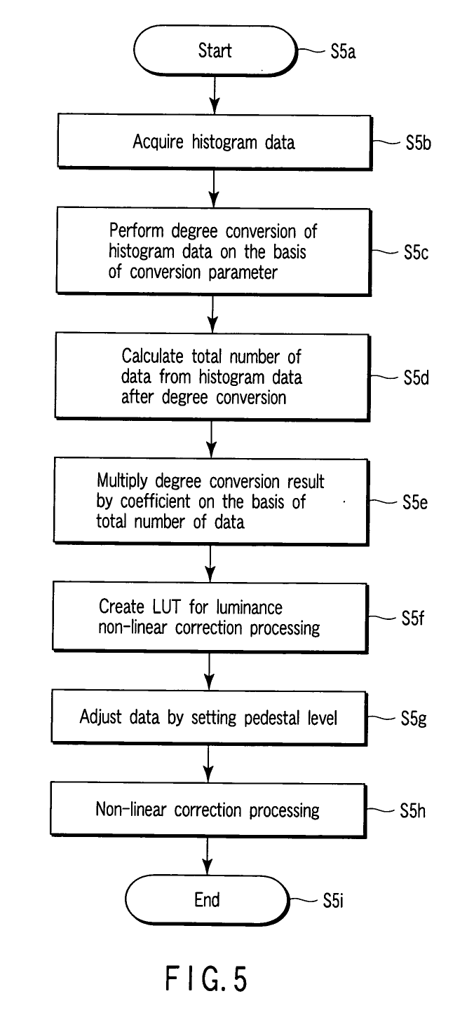

FIG. 5 is a flow chart in which one example of the non-linear correction processing which is performed by the non-linear correction processing unit 42 with respect to the luminance signal Y is summarized. That is, when the processing is started (in block S5a), the histogram data acquisition unit 42c acquires the histogram data with respect to the luminance in block S5b.

The histogram data is acquired by detecting a luminance level for each pixel with respect to the picture signal for one frame portion and counting the number of pixels corresponding to each luminance level. In this case, the resolution of the luminance level is set in a sufficiently minute manner. For example, in the case where the input picture signal is 8 bits, the resolution of the luminance level at the time of acquiring the histogram data is also set to 8 bits.

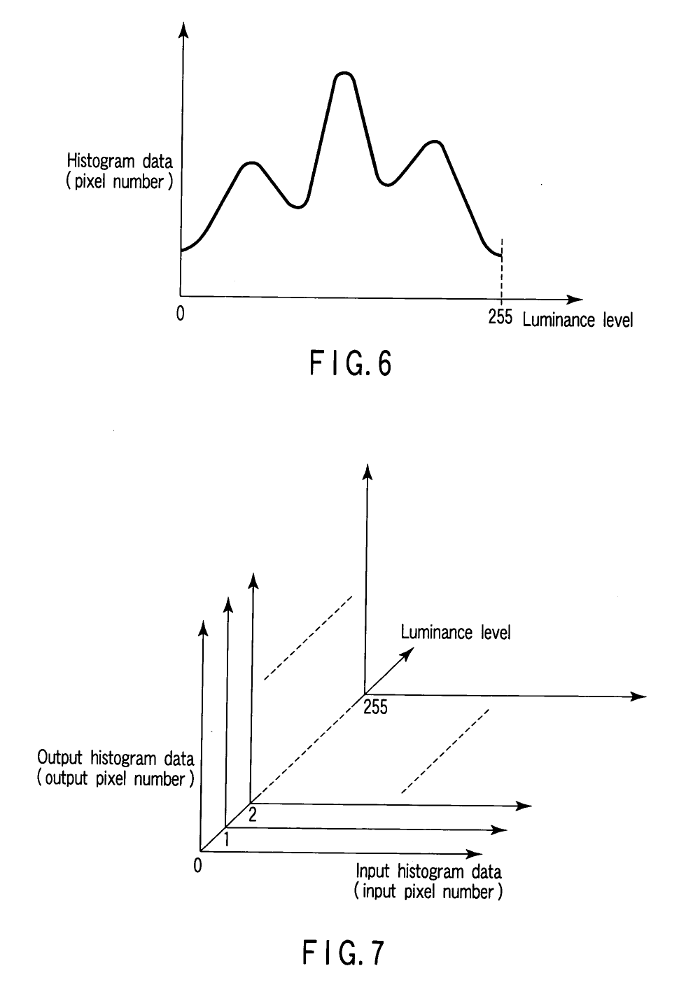

FIG. 6 shows one example of histogram data of the luminance for one frame portion, the data being acquired as described above. In this case, the resolution of the luminance is set to 8 bits (0 to 255). In other words, with respect to 256 levels of luminance from 0 to 255, the pixels are acquired in the number corresponding to respective luminance levels. As a consequence, when all the numbers of pixels on the respective luminance levels are added, the total number thereof becomes the same as the number of pixels for one frame portion which the input picture signal has.

Thereafter, in block S5c, the degree converter unit 42d performs a degree conversion processing on the basis of the conversion parameter supplied from the control unit 26 with respect to the acquired histogram data. The conversion parameter, as shown in FIG. 7, regulates the output histogram data with respect to the input conversion data respectively for each of the luminance levels 0 to 255.

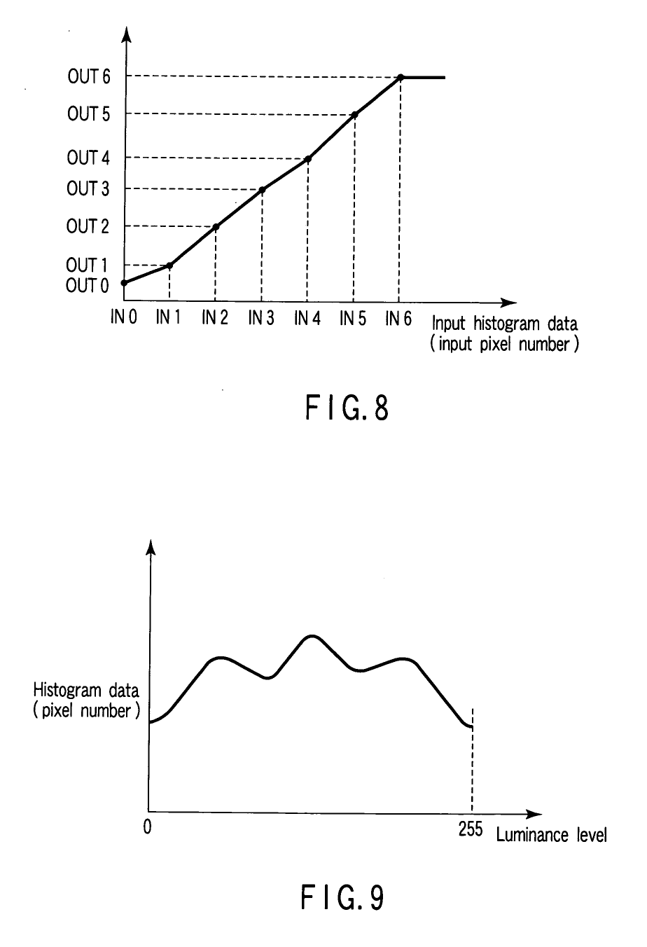

FIG. 8 shows one example of a conversion parameter with respect to the luminance level 0. In this conversion parameter, the amount of histogram data is large. For this reason, the input histogram data is plotted in equal intervals to regulate only output histogram data OUT0 to OUT6 corresponding to input histogram data positions IN0 to IN6 that are plotted. The spaces between the respective output histogram data OUT0 to OUT6 are handled by means of connection with a straight line.

Here, the histogram data shown in FIG. 6 is subjected to the degree conversion processing on the basis of the above-described conversion parameter, and is thereby subjected to a degree conversion as shown in, for example, FIG. 9. Thereafter, in block S5d, the LUT creation unit 42f calculates from the degree-converted histogram data the total number of data, namely, the total number of pixels corresponding to the range of 100% amplitude from the pedestal level of the picture signal.

Then, in block S5e, the LUT creation unit 42f sets a conversion value showing 100% amplitude to multiply the histogram data subjected to a degree conversion in block S5c by a coefficient such that the total number of data acquired in block S5d falls within the range of 100% amplitude from the pedestal level of the picture signal.

Thereafter, in block S5f, the LUT creation unit 42f creates a luminance input/output conversion parameter, namely a LUT for luminance non-linear correction processing by accumulating and adding from the low luminance level the histogram data multiplied by the coefficient and subjected to the degree conversion.

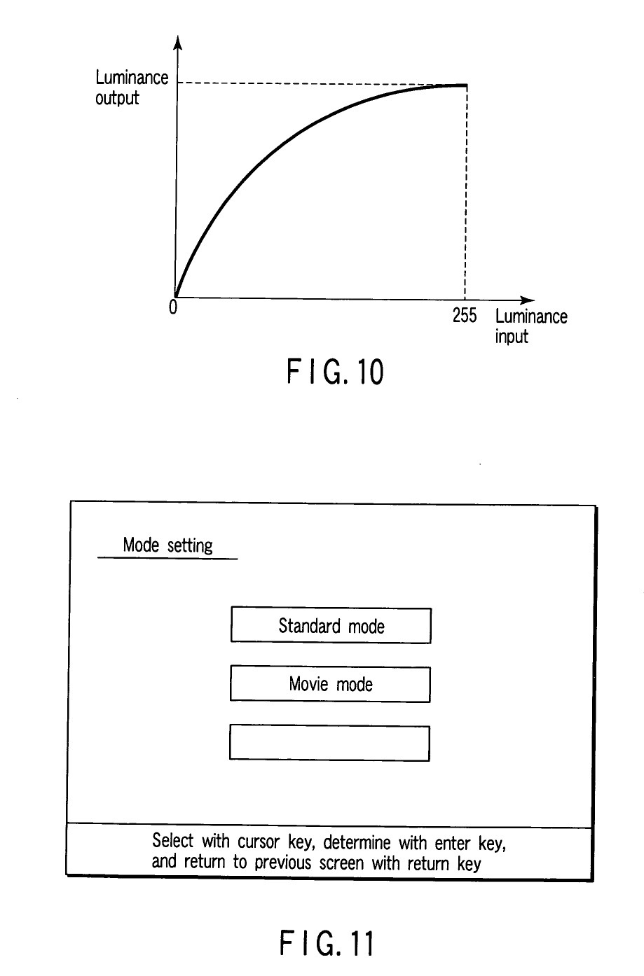

Then, the LUT creation unit 42f sets in block S5g the pedestal level to perform data adjustment, and the non-linear correction processing unit 42b performs in block S5h the non-linear correction processing to the luminance signal Y on the basis of the LUT to terminate the processing (in block S5i). FIG. 10 shows one example of a non-linear characteristic given to the luminance signal Y by the LUT for non-linear correction processing.

In the above-described embodiment, the degree conversion processing is performed by means of the conversion parameter which enables designating the histogram data to each of the luminance levels. As a consequence, the control range for the gradation correction processing with respect to the luminance can be flexibly changed in a variable manner, so that the luminance control suitable to the practical use can be performed.

Incidentally, the conversion parameter for performing the degree conversion processing to the histogram data is not limited to one kind. For example, a plurality of kinds of parameters corresponding to a standard mode, a movie mode or the like are prepared in advance in the non-volatile memory 30, thereby allowing the user to select and set the brightness corresponding to the mode.

This setting is made in such a manner that the user operates the operation unit 27 to display a mode setting screen as shown in FIG. 11 on the image display unit 25. As the mode setting screen, items such as “the standard mode” and “the movie mode” are displayed. Consequently, the brightness can be set by selecting any one of the items with a cursor key on the operation unit 27 and operating an enter key.

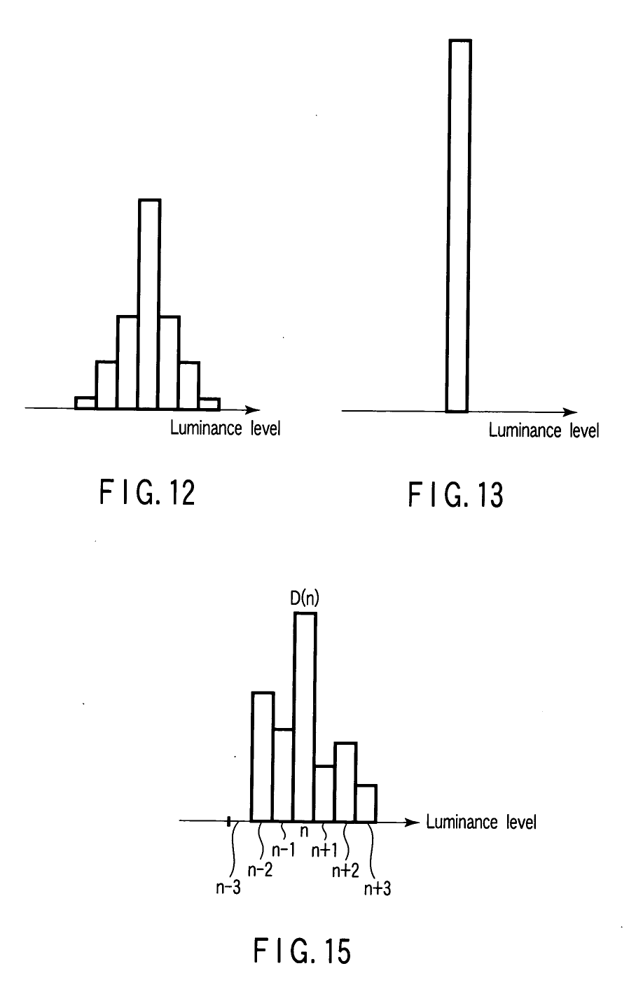

Next, a modified example of the above embodiment will be explained. Specifically, in the case of an analog picture signal, like the histogram data shown in FIG. 12, a luminance level is present which is expanded to the periphery of the original luminance level under the influence of noise or the like even in a signal having a high specific luminance level.

On the other hand, consideration will be given for the case where the input picture signal is an entirely bright image or an entirely dark image, or the case where digital broadcast contents are images which can be made uniformly flat without noise like animation images by means of computer graphics. In such a case, it sometimes happen that there is a tendency that when histogram information is sufficiently segmented, despite the presence of information on a certain luminance level, no information is present on adjacent luminance levels, that is, histogram data is not entirely scattered but rather concentrated on a specific location like the histogram data shown in FIG. 13. In this case, there is a possibility that an excessive gradation correction is performed in order to improve the amount of information of the portion where information are concentrated, so that images are damaged.

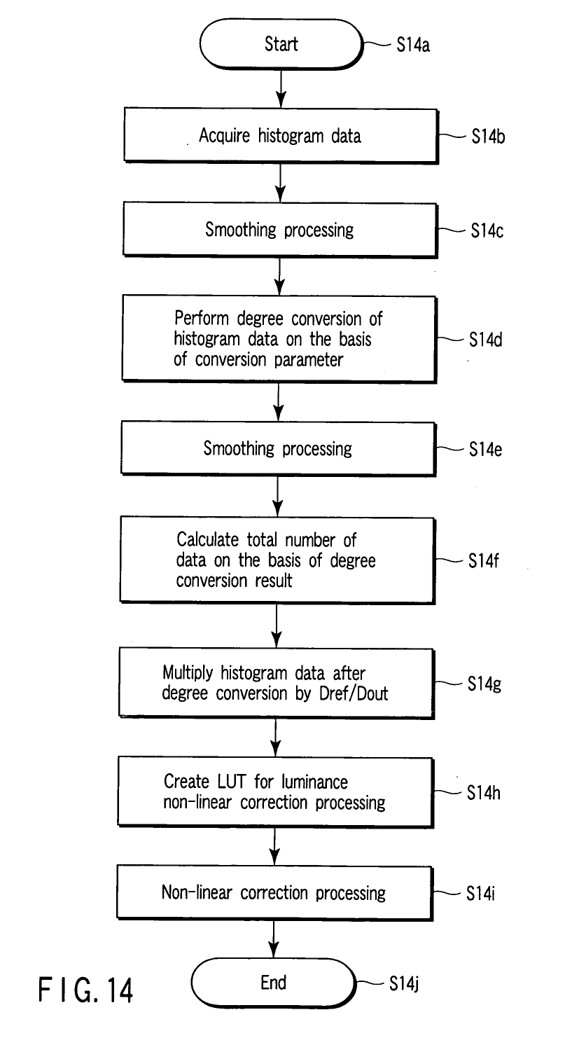

FIG. 14 is a flow chart in which, in such a case, a processing operation of the luminance non-linear correction processing 42 is summarized wherein the local concentration of histogram data is eliminated and a smoothing processing is added to dull the sensitiveness thereof. More specifically, when the processing is started (in block S14a), the luminance non-linear correction processing unit 42 acquires histogram data with respect to the luminance in block S14b.

Then, the luminance non-linear correction processing unit 42 performs in block S14c a smoothing processing with respect to the acquired histogram data. The smoothing processing is made, as shown in, for example, FIG. 15, by applying the following processing or the like to histogram data D(n) on a specific luminance level by using histogram data before and after the histogram data:
[D(n)+{D(n−1)+D(n+1)}/2]/2
[D(n)+D(n−1)+D(n+1)+{D(n−2)+D(n+2)}/2)/4
[D(n)+D(n−1)+D(n+1)+D(n−2)+D(n+2)+{D(n−3)+D(n+3)}/2]8

Incidentally, in the case where the histogram data acquired in block S14c has, as shown in FIG. 13, a characteristic such that the data are concentrated on a specific luminance level as shown in FIG. 13, the smoothing processing using histogram data before and after the histogram data on the specific luminance level.

Thus, the luminance non-linear correction processing unit 42 performs in block S14d a degree conversion processing based on the conversion parameter supplied from the control unit 26 with respect to the acquired histogram data, so that the histogram data shown in FIG. 13 is smoothed as shown in FIG. 15.

Thereafter, in block S14e, the luminance non-linear correction processing unit 42 performs a smoothing processing to the histogram data. In block S14f, as described above, the luminance non-linear correction processing unit 42 sets the pedestal level and 100% amplitude level on the basis of the degree conversion result, and calculates the data number Dout which falls in the range.

In block S14g, the luminance non-linear correction processing 42 multiplies the histogram data after the degree conversion by Dref (the data number on 100% amplitude level)/Dout. Thereafter, the luminance non-linear correction processing unit 42 accumulates and adds in block S14h from the low luminance level the histogram data subjected to degree conversion and multiplied by the coefficient, thereby preparing a luminance input/output conversion parameter, namely, an LUT for non-linear correction processing.

Then, the luminance non-linear correction processing unit 42 performs in block S14i the non-linear correction processing to the luminance signal Y on the basis of the LUT for luminance non-linear correction processing to terminate the processing (in block S14j).

That is, even when the histogram data are concentrated on a specific luminance level, the histogram data can be easily smoothed by means of the degree conversion processing using the conversion parameter. Consequently, it is possible to prevent the damage of the output image due to an excessive gradation control.

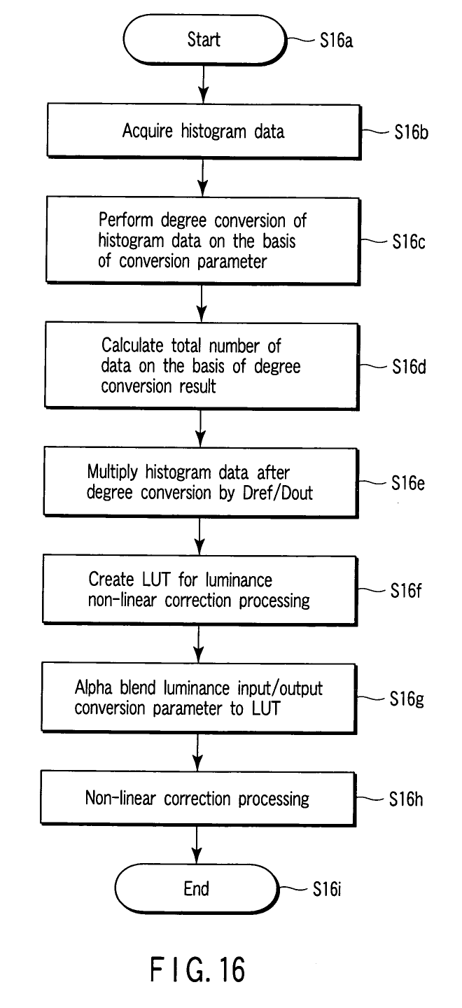

Next, another modified example of the above embodiment will be explained with reference to the flow chart shown in FIG. 16. More specifically, when the processing is started (in block S16a), the luminance non-linear correction processing unit 42 acquires in block S16b histogram data with respect to the luminance. In block S16c, the luminance non-linear correction processing unit 42 performs the degree conversion on the basis of the conversion parameter supplied from the control unit 26 to the acquired histogram data.

Thereafter, as described above, the luminance non-linear correction processing unit 42 sets in block S16d the pedestal level and the 100% amplitude level on the basis of the degree conversion result to calculate the data number Dout which falls in the range.

The luminance non-linear correction processing unit 42 multiplies the histogram data after the degree conversion by Dref (the data number of 100% amplitude level)/Dout in block S16e. In block S16f, the luminance non-linear correction processing unit 42 accumulate and add the histogram data subjected to the degree conversion and multiplied by the coefficient from the low luminance level, thereby preparing a luminance input/output conversion parameter, namely, a LUT for luminance non-linear correction processing.

Then, in block 16g, the luminance non-linear correction processing unit 42 alpha bends the luminance input/output conversion parameter which can be designated by the user to the LUT for luminance non-linear correction processing. In block S16h, the luminance non-linear correction processing unit 42 performs the non-linear correction processing to the luminance signal (Y) on the basis of the LUT after the alpha blend to terminate the processing (in block S16i).

More specifically, the luminance input/output conversion parameter which can be designated by the user is alpha blended with the LUT for luminance non-linear correction processing. As a consequence, it becomes possible to perform a gradation correction by means of the luminance input/output conversion parameter in addition to the gradation correction by means of the degree conversion. Plural kinds of luminance input/output conversion parameters are prepared in advance in, for example, the non-volatile memory 30, so that the user can appropriately select any of the parameters.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A picture signal processor comprising:
an input unit configured to receive a luminance signal;
an acquisition unit configured to acquire histogram data on each of luminance levels with respect to the luminance signal for one frame portion input to the input unit;
a converter unit configured to perform a degree conversion processing on the basis of a conversion parameter which is designated to a histogram on each luminance level with respect to the histogram data acquired by the acquisition unit;
a creation unit configured to create a non-linear correction processing table for performing a non-linear correction processing to the luminance signal input to the input unit on the basis of the histogram data subjected to the degree conversion processing by the converter unit; and
a processing unit configured perform a non-linear correction processing to the luminance signal input to the input unit on the basis of the non-linear correction processing table created by the creation unit.

2. A picture signal processor according to claim 1, wherein the conversion parameter used in the converter unit is constituted to regulate output histogram data to the input histogram data with respect to each of the luminance levels.

3. A picture signal processor according to claim 1, wherein the conversion parameter used in the converter unit is configured to regulate output histogram data corresponding to a plurality of predetermined positions of the input histogram data with respect to each of the luminance levels and to connect adjacent output histogram data with a straight line.

4. A picture signal processor according to claim 1, wherein the conversion parameter used in the converter unit is configured to perform a degree conversion processing to the histogram data acquired by the acquisition unit such that histogram data concentrated on a specific luminance level are smoothed with a luminance level before and after the specific luminance level.

5. A picture signal processor according to claim 1, wherein the creation unit comprises:
a circuit configured to calculate the total number of data from the histogram data subjected to the degree conversion processing by the converter unit;
a circuit configured to create a coefficient for allowing the calculated total number of data to correspond to the number of finally output data;
a circuit configured to multiply the histogram data by the created coefficient, the histogram data being subjected to the degree conversion processing by the converter unit; and
a circuit configured to create the non-linear correction processing table on the basis of the histogram data multiplied by the coefficient.

6. An image display device comprising:
a first input unit configured to receive a luminance signal;
an acquisition unit configured to acquire histogram data on each of luminance levels with respect to the luminance signal for one frame portion input to the fist input unit;
a converter unit configured to perform a degree conversion processing on the basis of a conversion parameter which is designated to a histogram on each luminance level with respect to the histogram data acquired by the acquisition unit;
a creation unit configured to create a non-linear correction processing table for performing a non-linear correction processing to the luminance signal input to the first input units on the basis of the histogram data subjected to the degree conversion processing by the converter unit;
a processing unit configured to perform a non-linear correction processing to the luminance signal input to the first input unit on the basis of the histogram data subjected to the non-linear correction processing table created by the creation unit;
a second input unit configured to receive a color signal;
a correction unit configured to perform an amplitude correction processing based on the luminance signal input to the first input unit with respect to the color signal input to the second input unit; and
a display unit configured to perform an image display on the basis of the color signal subjected to the amplitude correction processing by the correction units and the luminance signal subjected to the non-linear correction processing by the processing unit.

7. A picture signal processing method comprising:
a first block of inputting a luminance signal;
a second block of acquiring histogram data on each of luminance levels with respect to the luminance signal for one frame portion input in the first block;
a third block of performing a degree conversion on the basis of a conversion parameter which is designated to a histogram on each luminance level with respect to the histogram data acquired in the second block;
a fourth block of creating a non-linear correction processing table for performing a non-linear correction processing to the luminance signal input in the first block on the basis of the histogram data subjected to the degree conversion processing in block third block;
a fifth block of performing a non-linear correction processing to the luminance signal input in the first block on the basis of the non-linear correction processing table created in the fourth block.

8. A picture signal processing method according to claim 7, wherein the conversion parameter used in the third block regulates output histogram data to the input histogram data with respective to each luminance level.

9. A picture signal processing method according to claim 8, wherein the conversion parameter used in the third block is configured to regulate output histogram data corresponding to a plurality of predetermined positions of the input histogram data respectively on each luminance level and to connect adjacent output histogram data with a straight line.

10. A picture signal processing method according to claim 7, wherein the conversion parameter used in the third block performs a degree conversion processing to the histogram data acquired in the second block such that histogram data concentrated on a specific luminance are smoothed in accordance with a luminance level before and after the specific luminance level.

11. A picture signal processing method according to claim 7, wherein the fourth block comprises:
a block of calculating the total number of data from the histogram data subjected to the degree conversion processing in the third block;
a block of creating a coefficient for allowing the calculated total number of data to correspond to the number of finally output data; and
a block of multiplying the histogram data by the created coefficient, the histogram data being subjected to the degree conversion processing in the third block; and
a block of creating the non-linear correction processing table on the basis of the histogram data multiplied by the coefficient.

12. An image display method comprising:
a first block of inputting a luminance signal;
a second block of acquiring histogram data on each of luminance levels with respect to the luminance signal for one frame portion input in the first block;
a third block of performing a degree conversion processing on the basis of a conversion parameter which is designated to a histogram on each luminance level with respect to the histogram data acquired in the second block;
a fourth block of creating a non-linear correction processing table for performing a non-linear correction processing to the luminance signal input in the first block on the basis of the histogram data subjected to the degree conversion processing in the third block;
a fifth block of performing a non-linear correction processing to the luminance signal input in the first block on the basis of the non-linear correction processing table created in the fourth block; and
a sixth block of inputting a color signal;
a seventh block of performing an amplitude correction processing based on the luminance signal input in the first block with respect to the color signal input in the sixth block; and
an eighth block of performing an image display on the basis of the color signal subjected to the amplitude correction processing in the seventh block and the luminance signal subjected to the non-linear correction processing in the fifth block.
